(19) United States
(12) Patent Application Publication
(10) Pub. No.: US 2008/0294765 A1
(43) Pub. Date: Nov. 27, 2008

(54) DEVICE MANAGEMENT PROGRAM, COMMUNICATION DEVICE, AND DEVICE MANAGEMENT METHOD

(76) Inventor: Kotaro Kaneko, Osaka (JP)

Correspondence Address: FROMMER LAWRENCE & HAUG, 745 FIFTH AVENUE- 10TH FL., NEW YORK, NY, 10151, US

(21) Appl. No.: 12/124,735

(22) Filed: May 21, 2008

(30) Foreign Application Priority Data
May 24, 2007 (JP) 2007-137416

(51) Int. Cl. G06F 15/173

(52) U.S. Cl. 709/223

(57) ABSTRACT

The present invention teaches and claims a communication device including a communication section that performs communication with respect to a peripheral device for exchanging information; a delay time measuring section that measures a delay time elapsed from when the peripheral device is inquired for information acquisition until the peripheral device returns a response; and a delay time determining section that controls the number of communication sessions based on the delay time. The present invention further claims and teaches a device management method to maximizing communications sessions and minimizes response time.

### INCORPORATION BY REFERENCE

This application is based upon and claims the benefit of priority from the corresponding Japanese Patent Application No. 2007-137416, filed May 24, 2007, the entire contents of which is incorporated herein by reference.

### FIELD OF THE INVENTION

The present invention teaches and claims a device management program for managing a peripheral device such as an image forming apparatus, and more particularly, to a technology for optimizing the number of communication sessions in order to reduce time required in obtaining information from the peripheral device.

### BACKGROUND OF THE INVENTION

In communications between a device management program (utility) for performing a processing such as displaying of device information used for managing one or more peripheral devices such as a copier. The utility has a one-to-multitude relationship with the devices (peripheral devices). In order to reduce time required for obtaining information on every device, a necessity arises for establishing as many communication sessions as possible at minimal time, and for performing simultaneous communications asynchronously.

However, to execute the above-mentioned operations, resources of a computer on which the utility is operating on are consumed by the number of communication sessions, and the load on communication lines increases as well. Therefore, even if the number of devices is large, there are limitations imposed on communication sessions to be performed.

Because the total communication time and consumption of resources have a trade-off relationship, the key is to establish the most optimal balance between the number of communication sessions and the time needed to relay the information.

### SUMMARY OF THE INVENTION

According to one aspect of the present invention, a computer readable medium having a device management program, the device management program is executed on a computer of a user terminal to manage a peripheral device, the device management program causes the computer to implement: (1) a communication function for performing communications with respect to the peripheral device to exchange information; (2) a delay time measuring function for measuring a delay time elapsed since the peripheral device is inquired for information acquisition until the peripheral device returns a response; and (3) a delay time determining function for controlling the number of communication sessions based on the delay time.

According to another aspect of the present invention, a computer readable medium having a device management program, the device management program is executed on a computer of a user terminal to manage a peripheral device, the device management program causes the computer to implement: (1) a communication function for performing communications with respect to the peripheral device for exchanging information; (2) a resource utilization state measuring function for measuring a resource utilization state of the user terminal; and (3) a resource utilization state determining function for controlling the number of communication sessions based on the resource utilization state.

With the computer readable medium, the communication device, and the device management method according to the present invention, it is possible to automatically decide the optimum number of communication sessions of the device management program, and to obtain device information from the peripheral device without impairing the efficiency of the device management program.

The above and other objects, features, and advantages of the present invention will be more apparent from the following detailed description taken in conjunction with the accompanying drawings.

In this text, the terms “comprising”, “comprise”, “comprises” and other forms of “comprise” can have the meaning ascribed to these terms in U.S. Patent Law and can mean “including”, “include”, “includes” and other forms of “include”.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings in which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 is a block diagram of an image forming apparatus and a user terminal according to one embodiment of the present invention;

FIG. 2 is a flowchart of determination as to whether or not the number of communication sessions is to be increased/decreased by use of a communication delay time according to one embodiment of the present invention; and

FIG. 3 is a flowchart of determination as to whether or not the number of communication sessions is to be incremented or decremented by use of a resource utilization state according to an embodiment of the present invention.

### DETAILED DESCRIPTION OF THE PREFERRED EMBODIMENTS

Reference will now be made in detail to various embodiments of the invention, one or more examples of which are illustrated in the accompanying drawings. Each example is provided by way of explanation of the invention, and by no way limiting the present invention. In fact, it will be apparent to those skilled in the art that various modifications, combination, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations come within the scope of the appended claims and their equivalents.

An embodiment of the present invention provides a device management program for managing a peripheral device including but not limited to a copier. The embodiment of the present invention remedies the shortcomings of the conventional peripheral device in determining an optimum number of sessions required for efficiently obtaining information from one or more the peripheral devices in a minimal time and the process can be automated. The embodiment of the present invention comprising using at least one of a method of controlling the number of communication sessions based on a response time elapsed until a response is returned from the peripheral device and a method of controlling the number of communication sessions based on a resource utilization state of a computer executing the device management program.

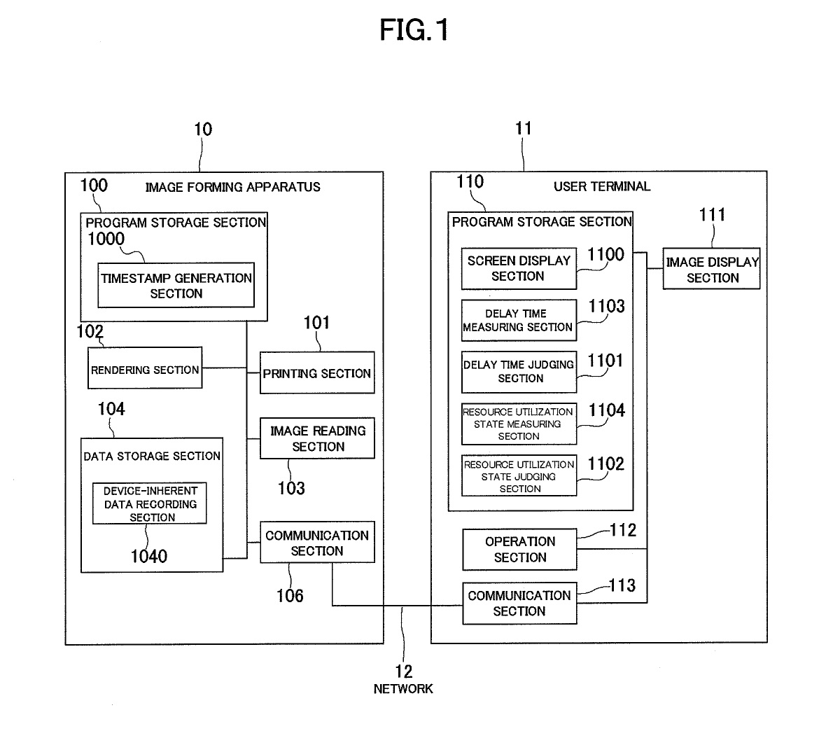

FIG. 1 shows an embodiment of a system configuration that is required for a device management program (utility) to display device information on an image forming apparatus 10 such as a copier or printer in order to appropriately perform simultaneous communications. The system in FIG. 1 comprises a user terminal 11 for displaying the device information; an image forming apparatus 10 to support internationalization; and a network 12 such as a local area network (LAN) for connecting between the user terminal 11 and the image forming apparatus 10.

The image forming apparatus 10 includes a printing section 101, a rendering section 102, an image reading section 103, and a data storage section 104. The image forming apparatus 10 additionally includes: a program storage section 100 for determining a line-to-line activity ratio; and a communication section 106. In response to a request from the utility, a timestamp generation section 1000 of the program storage section 100 appends a current time to device-inherent data stored in a device-inherent data recording section 1040 of the data storage section 104, and outputs the result from the communication section 106 of the image forming apparatus to a user terminal communication section 113 via the network.

The user terminal 11 is, for example, a personal computer, operates as a communication device that includes: an image display section 111 such as a CRT display; an operation section 112 such as a keyboard and mouse for selection of a connection destination; a program storage section 110; and the user terminal communication section 113 connected to the network. The program storage section 110 includes: a screen display section 1100 implemented by displaying the device information on a screen; a delay time measuring section 1103 that measures a respective delay time by obtaining a current timestamp and the previous timestamp; a delay time determining section 1101 that controls the number of sessions based on the delay time measured by delay time measuring section 1103; a resource utilization state measuring section 1104 that measures a resource utilization state of the user terminal 11; and a resource utilization state determining section 1102 that controls the number of sessions based on the resource utilization state measured by the resource utilization state measuring section 1104.

The resource utilization state of the user terminal 11 represents factors including but not limited to, for example, CPU activity ratio, main memory activity ratio, and disk input/output frequency (hereinafter, referred to as “disk I/O frequency”).

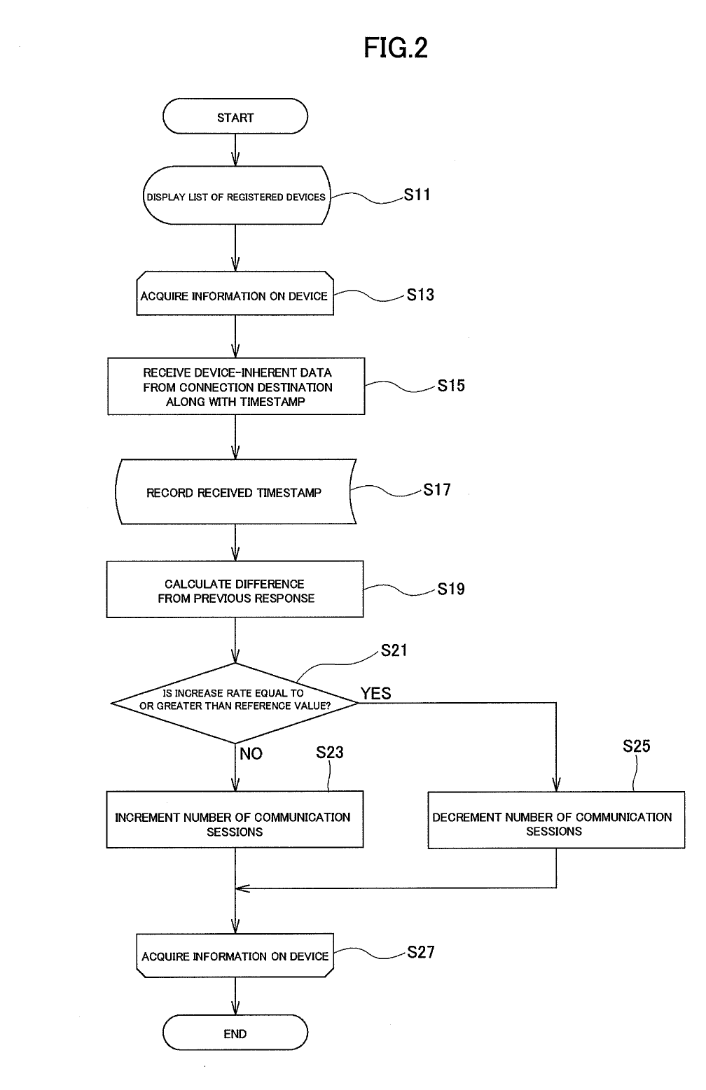

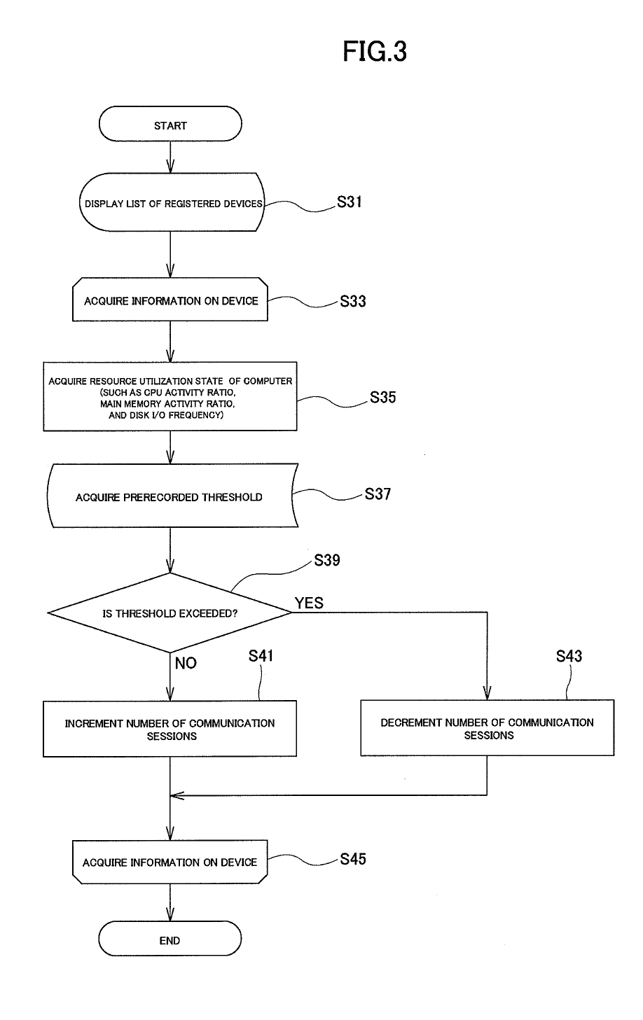

Hereinafter, description will be made of processing flows of the embodiment referring to FIG. 2, which is a flowchart of judgment as to whether or not the number of communication sessions is to be incremented or decremented by use of a communication delay time and FIG. 3, which is a flowchart of determination as to whether or not the number of communication sessions is to be incremented or decremented by use of a resource utilization state.

FIGS. 2 and 3 differ in the sections used for controlling the number of communication sessions. Specifically, the number of communication sessions is adjusted in FIG. 2 based on a response time elapsed since the user terminal 11 makes an inquiry about management information base (hereinafter referred to as “MIB”) to a device, and the embodiment in FIG. 3 is based on the CPU activity ratio, main memory activity ratio, and disk I/O frequency of the user terminal 11.

The number of communication sessions affects the line activity ratio and the resource utilization state (the CPU activity ratio, main memory activity ratio, and disk I/O frequency) of the user terminal 11, and also the processing time. Therefore, the communication delay time and the resource utilization state are used to automatically adjust the number of communication sessions.

In one or more embodiments, a reference value or threshold may be used to determine as to whether or not to increase or decrease the number of communication sessions. The reference value and threshold are maybe predetermined by a network maintenance man or a peripheral device designer, and the predetermined value (i.e. the reference value or threshold) may then stored in a peripheral device for its initial settings. The reference value maybe based on an increased rate referring to a difference between a current delay time and a previous delay time. Similarly the threshold maybe based on the resource utilization state. Therefore both the reference value and the threshold are real numbers, and further they can be either an integers or non-integers.

In one embodiment of the present invention, the communication delay time is determined based on a timestamp appended to the MIB or the like of the device on an information acquisition basis. In a general network architecture having a layered structure such as the TCP/IP, a lower layer is not involved in information exchanged on an upper layer, which makes it difficult to identify a relationship between a communication packet and a device model. Also the processing speed differs depending on the device model, so it is more effective for a host-side application to handle timestamp information. This device management method is used in one of the embodiments of the present invention.

First, the flowchart of FIG. 2 is used to describe a procedure for determining whether or not the number of communication sessions is to be increased and/or decreased by use of the communication delay time.

In Step S11, the screen display section 1100 displays a list of registered devices on the image display section 111.

Step S13 is the start of a loop with Step S27 at the end. After the user terminal communication section 113 has the device management program perform the following series of operations for obtaining necessary information on one (image forming apparatus in this embodiment) of the devices that are list-displayed in Step S11, the loop is repeated to perform a series of operations on a subsequent device such as subsequent different image forming apparatus.

In Step S15, the user terminal communication section 113 receives device-inherent data from the connection destination along with a timestamp.

In Step S17, the delay time measuring section 1103 records the received timestamp, and further records the time elapsed from when a call is issued to the device until a response is returned there from, as a response time.

In Step S19, the delay time measuring section 1103 calculates the difference between the previous response time and the current response time to obtain an increase rate.

In Step S21, the delay time determining section 1101 determines whether or not the increase rate obtained in Step S19 is equal to or greater than a reference value. When the increase rate is equal to or greater than the reference value, the procedure advances to Step S25. When the increase rate is less than the reference value, the procedure advances to Step S23.

In Step S23, the delay time determining section 1101 increases the number of communication sessions.

In Step S25, the delay time determining section 1101 decreases the number of communication sessions.

In Step S27, the subject of the information acquisition shifts to the subsequent device, and the procedure returns to the start of the loop in Step S13.

The series of operations are thus brought to an end.

Next, the flowchart of FIG. 3 is used to describe a method or procedure for determining whether or not the number of communication sessions is to be increased or decreased by using the resource utilization state.

In Step S31, the screen display section 1100 displays a list of registered devices on the image display section 111.

Step S33 is the start of a loop with Step S45 at the end. After the user terminal communication section 113 has the device management program perform the following series of operations for obtaining necessary information on one image forming apparatus of this embodiment of the devices that are list-displayed in Step S31, the loop is repeated in order to perform series of operations on a subsequent device (subsequent different image forming apparatus).

In Step S35, the resource utilization state measuring section 1104 obtains the resource utilization state of a computer of the user terminal 11. The obtained resource utilization state represents but is not limited to factors such as a CPU activity ratio, a main memory activity ratio, and/or a disk I/O frequency.

In Step S37, the resource utilization state determining section 1102 obtains a predetermined threshold of the resource utilization state.

In Step S39, the resource utilization state determining section 1102 determines whether or not the resource utilization state of the computer obtained in Step S35 exceeds the threshold obtained in Step S37. When any one of the factors of the resource utilization state has a value exceeding the threshold, the procedure advances to Step S43. When none of the factors of the resource utilization state has a value exceeding the threshold, the procedure advances to Step S41.

In Step S41, the resource utilization state determining section 1102 should increase the number of communication sessions.

In Step S43, the resource utilization state determining section 1102 should decrease the number of communication sessions.

In Step S45, the subject of the information acquisition is shifted to the subsequent device, and the procedure returns to the start of the loop in Step S13.

The series of operations are thus brought to an end.

With the device management program according to the embodiment of the present invention as disclosed in the preceding paragraphs for the purpose of optimizing the management of the device, it is possible to automatically maintain the number of communication sessions of the peripheral device at an optimum number by the user terminal.

The execution of the device management program according to an embodiment of the present invention is capable of optimizing the number of communication sessions and eliminating the problems that too many communication sessions consume the resources on the user terminal and thereby reduce response speed. The device in accordance with an embodiment of the present invention management program also eliminates the problems when insufficient number of communication sessions produce overhead for opening/closing a communication session each time a peripheral device is inquired about information and thereby delay the response with respect to the peripheral device. Consequently, the peripheral device can be managed effectively with a short response time.

In the method shown in FIG. 2 of increasing and/or decreasing the number of communication sessions based on the delay time, the delay time may be calculated by measuring the time elapsed since the user terminal makes an inquiry about information until the user terminal receives a response thereto. Alternatively, by using the timestamp obtained from the peripheral device as shown in the flowchart of FIG. 2, the delay time may be calculated by measuring the time elapsed since the peripheral device returns a response until the user terminal receives the response. Alternatively, a response time may be calculated by measuring Timestamp 1 received from the user terminal by the peripheral device and Timestamp 2 returned to the user terminal by the peripheral device, and subtracting the time (Timestamp 2−Timestamp 1), which is required for obtaining the MIB information by the peripheral device, from the delay time.

FIG. 3 shows another embodiment according to the present invention. FIG. 3 depicts the method of incrementing or decrementing the number of communication sessions based on the resource utilization state, the resource utilization state determining section 1102 determines whether or not the number of sessions is to be incremented/decremented based on whether or not any one of the CPU activity ratio, the main memory activity ratio, and the disk I/O frequency has a value exceeding the threshold. Alternatively, when all of the above-mentioned factors have a value exceeding the threshold, the number of sessions may be determined to be decremented, and when all of the above-mentioned factors have a value below the threshold, the number of sessions may be determined to be incremented.

Further, the resource utilization state determining section 1102 may perform its determination based on any one of or a combination of the CPU activity ratio, the main memory activity ratio, the disk I/O frequency, and other related performance factors. The resource utilization state may include other factors such as a communication line activity ratio and an activity ratio with respect to an upper limit to which a communication line interface can process. Thus, the method according to the present invention of determining whether or not the number of communication sessions is to be incremented or decremented is not limited to the embodiments described herein and the accompanying flowcharts.

Alternatively, the number of communication sessions may be controlled by using both of the methods shown and described in FIGS. 2 and 3.

Further, the device management program provided in a computer readable recording medium including but not limited to a ROM (Read-Only Memory), a hard disk, a flexible disk, a memory card, or an optical disk.

According to one aspect of the present invention, there is provided a computer readable medium having a device management program, the device management program is executed on a computer of a user terminal to manage a peripheral device. The device management program causes the computer to implement: (1) a communication function for performing communications with respect to the peripheral device in order to exchange information; (2) a delay time measuring function for measuring a delay time elapsed since the peripheral device is inquired for information acquisition until the peripheral device returns a response; and (3) a delay time determining function for controlling the number of communication sessions based on the delay time.

In the device management program, when timestamp information is appended to the response from the peripheral device, the delay time measuring function measures the delay time during the communications between the peripheral device and the user terminal based on the timestamp information.

In the device management program, the delay time determines the function of decreasing the number of communication sessions when an increase rate of a difference between the delay time obtained based on the timestamp information received from the peripheral device and the delay time measured previously is equal to or greater than a reference value, and increasing the number of communication sessions when the increase rate is less than the reference value.

The device management program further causes the computer to implement: (1) a resource utilization state measuring function for measuring a resource utilization state of the user terminal; and (2) a resource utilization state determining function for controlling the number of communication sessions based on the resource utilization state. The number of communication sessions is controlled by at least one of the delay time measuring function and the resource utilization state measuring function.

According to yet another aspect of the present invention, there is provided a computer readable medium storing a device management program, the device management program is executed on a computer of a user terminal to manage a peripheral device, the device management program causes the computer to implement: (1) a communication function for performing communications with respect to the peripheral device in order to facilitate the exchange information; (2) a resource utilization state measuring function for measuring a resource utilization state of the user terminal; and (3) a resource utilization state determining function for controlling the number of communication sessions based on the resource utilization state.

In the device management program, the resource utilization state includes any one of or any combination of a CPU activity ratio, a main memory activity ratio, and a disk input/output frequency.

In the device management program, the resource utilization state determining function decreases the number of communication sessions when the resource utilization state is equal to or greater than a threshold, and increases the number of communication sessions when the resource utilization state is less than the threshold.

According to a further aspect of the present invention, a communication device in accordance with the present invention manages a peripheral device and the communication device including but not limited to: (1) a communication section that performs communications with respect to the peripheral device to exchange information; (2) a delay time measuring section that measures a delay time elapsed since the peripheral device is inquired for information acquisition until the peripheral device returns a response; and (3) a delay time determining section that controls the number of communication sessions based on the delay time.

In the communication device, when timestamp information is appended to the response from the peripheral device, the delay time measuring section measures the delay time during the communications between the peripheral device and the communication device based on the timestamp information.

Additionally, the delay time determining section regulates the number of communication sessions based on the difference between a reference value and an increased rate obtained from the peripheral device and a user terminal. The communication device further includes a resource utilization state measuring section that measures a resource utilization state of the communication device; and a resource utilization state determining section that controls the number of communication sessions based on the resource utilization state. And then the number of communication sessions is controlled by at least one of the delay time measuring function and the resource utilization state measuring function. A further aspect of the present invention provides a communication device for managing a peripheral device, including but not limited to: (1) a communication section that performs communications with respect to the peripheral device to exchange information; (2) a resource utilization state measuring section that measures a resource utilization state of a user terminal; and (3) a resource utilization state determining section that controls the number of communication sessions based on the resource utilization state.

In the communication device, the resource utilization state includes but not limited to any one of or any combination of a CPU activity ratio, a main memory activity ratio, and/or a disk input/output frequency.

In the communication device, the resource utilization state determining section decreases the number of communication sessions when the resource utilization state is equal to or greater than a threshold, and increases the number of communication sessions when the resource utilization state is less than the threshold.

A further aspect of the present invention provides a device management method for managing a device state of a peripheral device by causing a user terminal to perform communications with the peripheral device to obtain information there from including the steps of: (1) performing communications with the peripheral device; (2) measuring a delay time elapsed since the peripheral device is inquired for information acquisition until the peripheral device returns a response; and (3) controlling the number of communication sessions based on the measured delay time.

The device management method further includes the steps of:—measuring a resource utilization state of the communication device; and controlling the number of communication sessions based on the resource utilization state. The number of communication sessions is controlled by at least one of the delay time measuring function and the resource utilization state measuring function. According to yet a further aspect of the present invention, the present invention provides a device management method for managing a device state of a peripheral device by causing a user terminal to perform communications with the peripheral device to obtain information there from, including the steps of: (1) measuring a resource utilization state of the user terminal; and (2) controlling the number of communication sessions based on the resource utilization state. In the management method, measuring a resource utilization state further includes measuring any one of or any combination of a CPU activity ratio, a main memory activity ratio, and a disk input/output frequency.

Having thus described in detail preferred embodiments of the present invention, it is to be understood that the invention defined by the foregoing paragraphs is not to be limited to particular details and/or embodiments set forth in the above description, as many apparent variations thereof are possible without departing from the spirit or scope of the present invention.

What is claimed is:

1. A computer readable medium having a device management program, the device management program being executed on a computer of a user terminal to manage a peripheral device, the device management program causing the computer to implement:
a communication function for performing communications with respect to the peripheral device to exchange information;
a delay time measuring function for measuring a delay time elapsed since the peripheral device is inquired for information acquisition until the peripheral device returns a response; and
a delay time determining function for controlling the number of communication sessions based on the delay time.

2. The computer readable medium according to claim 1, wherein when timestamp information is appended to the response from the peripheral device, the delay time measuring function measures the delay time during the communications between the peripheral device and the user terminal based on the timestamp information.

3. The computer readable medium according to claim 1, wherein the delay time determining function changes the number of communication sessions when there is an increased rate based on a difference between the delay time obtained based on the timestamp information received from the peripheral device and the delay time measured previously.

4. The computer readable medium according to claim 3, wherein the delay time determining function decreases the number of communications sessions when the increased rate is equal to or greater than a reference value.

5. The computer readable medium according to claim 3, wherein the delay time determining function increases the number of communications sessions when the increased rate is less than a reference value.

6. The computer readable medium according to claim 1, wherein the device management program further causes the computer to implement:
a resource utilization state measuring function for measuring a resource utilization state of the user terminal; and
a resource utilization state determining function for controlling the number of communication sessions based on the resource utilization state,
wherein the number of communication sessions is controlled by at least one of the delay time measuring function and the resource utilization state measuring function.

7. A computer readable medium having a device management program, the device management program being executed on a computer of a user terminal to manage a peripheral device, the device management program prompting the computer to implement:
a communication function for performing communications with respect to the peripheral device for exchanging information;
a resource utilization state measuring function for measuring a resource utilization state of the user terminal; and
a resource utilization state determining function for controlling the number of communication sessions based on the resource utilization state.

8. The computer readable medium according to claim 7, wherein the resource utilization state includes any one of or any combination of a CPU activity ratio, a main memory activity ratio, and/or a disk input/output frequency.

9. The computer readable medium according to claim 7, wherein the resource utilization state determining function decreases the number of communication sessions when the resource utilization state is equal to or greater than a threshold, and increases the number of communication sessions when the resource utilization state is less than the threshold.

10. A communication device for managing a peripheral device, comprising:
a communication section that performs communication with respect to the peripheral device for exchanging information;
a delay time measuring section that measures a delay time elapsed from when the peripheral device is inquired for information acquisition until the peripheral device returns a response; and
a delay time determining section that controls the number of communication sessions based on the delay time.

11. The communication device as claimed in claim 10, wherein when timestamp information is appended to the response from the peripheral device, the delay time measuring section measures the delay time during the communications between the peripheral device and the communication device based on the timestamp information.

12. The communication device claimed in claim 11 wherein the delay time determining section regulates the number of communication sessions based on the difference between a reference value and an increased rate obtained from the peripheral device and a user terminal.

13. The communication device as claimed in claim 10 further comprises:
a resource utilization state measuring section that measures a resource utilization state of the communication device; and
a resource utilization state determining section that controls the number of communication sessions based on the resource utilization state,
wherein the number of communication sessions is controlled by at least one of the delay time measuring function and the resource utilization state measuring function.

14. A communication device for managing a peripheral device, comprising:
a communication section that performs communications with respect to the peripheral device for exchanging of information;
a resource utilization state measuring portion that measures a resource utilization state of a user terminal; and
a resource utilization state determining section that controls the number of communication sessions based on the resource utilization state.

15. The communication device as claimed in claim 14, wherein the resource utilization state comprises any one or any combination of a CPU activity ratio, a main memory activity ratio, and a disk input/output frequency.

16. The communication device according to claim 14, wherein the resource utilization state determining section decreases the number of communication sessions when the resource utilization state is equal to or greater than a threshold.

17. The communication device according to claim 14, wherein the resource utilization state determining section increases the number of communication sessions if the resource utilization state is less than a threshold.

18. A device management method for managing a device state of a peripheral device by causing a user terminal to perform communications with the peripheral device to obtain information there from, comprising the steps of:
performing communications with the peripheral device;
measuring a delay time elapsed since the peripheral device is inquired for information acquisition until the peripheral device returns a response; and
controlling the number of communication sessions based on the measured delay time.

19. The method according to claim 18 further comprising:
measuring a resource utilization state of the communication device; and
controlling the number of communication sessions based on the resource utilization state,
wherein the number of communications sessions is controlled by at least one of the delay time measuring function and the resource utilization state measuring function.

20. A device management method for managing a device state of a peripheral device by causing a user terminal to perform communications with the peripheral device for obtaining information there from, comprising the steps of:
measuring a resource utilization state of the user terminal; and
controlling the number of communication sessions based on the resource utilization state.

21. The method according to claim 20, wherein measuring a resource utilization state further comprises measuring any one of or any combination of a CPU activity ratio, a main memory activity ratio, and a disk input/output frequency.
